(19) United States
(12) Patent Application Publication
(10) Pub. No.: US 2026/0206816 A1
(43) Pub. Date: Jul. 23, 2026

(54) CASING AND METHOD OF USE

(71) Applicant: Flavorseal, LLC, Avon, OH (US)

(72) Inventors: John WURZBURGER, Davidson, NC (US); Lisa A. VACCO-ORLOWSKI, Rocky River, OH (US); Michael SCHMAL, Orwigsburg, PA (US); John LAMPLE, Libertyville, IL (US)

(21) Appl. No.: 19/139,904

(22) PCT Filed: Dec. 19, 2023
(86) PCT No.: PCT/US2023/084869

§ 371 Date: Jun. 17, 2025

Related U.S. Application Data
(60) Provisional application No. 63/433,637, filed on Dec. 19, 2022.

(51) Int. Cl. A23P 20/10

(52) U.S. Cl. CPC A23P 20/10

(57) ABSTRACT

Casings for foodstuffs, and in particular biaxially-oriented heat shrink-able casings, comprising one or more additives adhered to an interior surface of the casing, capable of improving processing yield and reducing purge, as well as a method of use of said casing, are described herein.

### CROSS-REFERENCE TO RELATED CASES

This case claims priority to, and the benefit of, U.S. Provisional Application Ser. No. 63/433,637, filed on Dec. 19, 2022 (Attorney Docket No. 35673.04106), the entire disclosure of which is incorporated herein by reference in its entirety as though fully recited herein.

### FIELD OF THE INVENTION

The general inventive concepts relate to casings for foodstuffs, and in particular biaxially-oriented casings, comprising one or more additives adhered to an interior surface of the casing, capable of optimizing net shrink, improving processing yield and reducing purge in a finished food product. In addition, the invention relates to a method of use of said casing.

### BACKGROUND

Casings, especially artificial casings containing substances, such as food dyes, spices, fruits, odorants and/or flavorings, which are transferable to the exterior surface of foodstuffs are already known. The food processing industry often uses biaxially-oriented polymer casings with shrink properties to leave an appealing smooth surface on the finished food product. Recently, biaxially-oriented casings have been used to transfer spice coating affixed to the inside of said casing to the exterior of finished food products.

### SUMMARY

Various exemplary embodiments of the present inventive concepts are directed to a casing comprising a biaxially-oriented casing matrix, an adhesive layer, and one or more additives affixed to the adhesive layer, wherein the casing improves yield of a finished food product by greater than 1%.

Various exemplary embodiments of the present inventive concepts are directed to a method of transferring an additive to a foodstuff. In some exemplary embodiments, the method comprises introducing a foodstuff into a casing, the casing comprising at least one of a biaxially-oriented matrix layer, an adhesive layer, and at least one of an additive, transferring said at least one additive to an external surface of the foodstuff, and processing the foodstuff within the casing, wherein the casing improves yield of a finished food product by greater than 1%.

Numerous other aspects, advantages, and/or features of the general inventive concepts will become more readily apparent from the following detailed description of exemplary embodiments and from the accompanying drawings being submitted herewith.

### BRIEF DESCRIPTION OF THE DRAWINGS

The general inventive concepts, as well as illustrative embodiments and advantages thereof, are described below in greater detail, by way of example, with reference to the drawing in which:

FIG. 1 is a partial cross-sectional view of an exemplary casing in accordance with an exemplary embodiment of the present application.

### DETAILED DESCRIPTION

Unless otherwise defined, all technical and scientific terms used herein have the same meaning as commonly understood by one of ordinary skill in the art to which these exemplary embodiments belong. The terminology used in the description herein is for describing particular exemplary embodiments only and is not intended to be limiting of the exemplary embodiments. Accordingly, the general inventive concepts are not intended to be limited to the specific embodiments illustrated herein. Although any methods and materials similar or equivalent to those described herein can be used in the practice or testing of the present invention, the preferred methods and materials are described herein.

As used in the specification and the appended claims, the singular forms “a,” “an,” and “the” are intended to include the plural forms as well, unless the context clearly indicates otherwise.

Unless otherwise indicated, all numbers expressing quantities of ingredients, processing conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present exemplary embodiments. At the very least each numerical parameter should be construed in light of the number of significant digits and ordinary rounding approaches.

Notwithstanding that the numerical ranges and parameters setting forth the broad scope of the exemplary embodiments are approximations, the numerical values set forth in the specific examples are reported as precisely as possible. Any numerical value, however, inherently contains certain errors necessarily resulting from the standard deviation found in their respective testing measurements. Every numerical range given throughout this specification and claims will include every narrower numerical range that falls within such broader numerical range, as if such narrower numerical ranges were all expressly written herein.

Biaxially-oriented casing or film refers to a material stretched in both machine (MD) and transverse (TD) directions, producing polymeric chains oriented parallel to the plane of said material. Biaxially oriented casing or films exhibit improved flexibility, tensile strength, and shrink ability and can be made to retain shape memory. Biaxially-oriented casing or films can be used as heat-shrinkable material, which will shrink and revert to dimensions approaching their pre-stretched shape. As disclosed herein, the percentage of shrink (in %) exhibited by a biaxially-oriented casing or film is expressed as the average of the percentage of shrink exhibited in the machine and transfers directions, i.e., shrink percentage (%)=(MD shrink %+TD shrink %)/2.

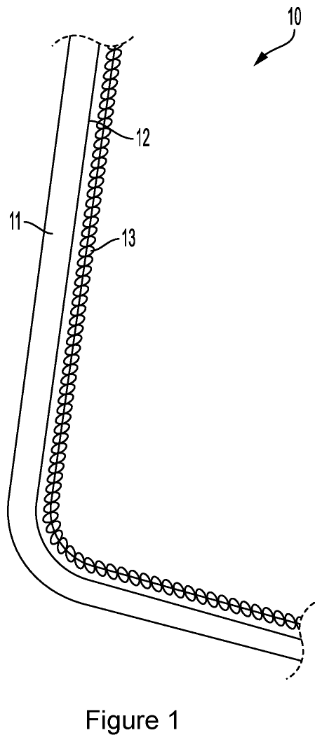

Referring to FIG. 1, a casing in accordance with certain aspects of the present application is shown generally at 10. The exemplary casing 10 includes a biaxially-oriented casing matrix 11, an adhesive layer 12 bound to the casing matrix, and an additive layer 13 embedded on the adhesive layer. The present invention accordingly relates to a casing having a single-layer or multilayer biaxially-oriented casing matrix, an adhesion layer firmly bound to the casing matrix, and at least one of an additive in contact therewith. In exemplary embodiments, the casing is used as a casing for any suitable foodstuff. As used herein, the term “foodstuff” may be any substance that can be used or prepared for use as a food, including but not limited to beef, pork, poultry, and non-meat proteins, or any food product, vegetable, cheese, or any other edible substance capable of being pumped through stuffing equipment.

In exemplary embodiments, the casing is a tube constructed from a flat film or extruded in tubular format, wherein the film is sealed into a tube or extruded into a tubular form. In exemplary embodiments, the casing comes in shirred format for high-speed automated stuffing, roll stock or cut pieces for individual stuffing via a stuffing horn. The casing may be used to make products in a wide range of shapes, including, for example, round, square, oval and D-shaped.

In exemplary embodiments, the casing matrix is a biaxially-oriented casing comprising at least one layer of extrudable resin. The extrudable resin may be any resin capable of being extruded, comprised of one or more of a polymers of natural and/or synthetic origin, including but not limited to polyamides, such as PA 6 or PA 6.6, ethylene vinyl alcohol (EVOH), polyethylene (PE), and sealants. Polyethylene is particularly suitable for combination with the polyamide inner layer. In exemplary embodiments, the casing matrix comprises multiple layers, wherein each layer is formed of an extrudable resin. In exemplary embodiments, the casing matrix comprises 1-7 layers, and preferably 3-7 layers. In some exemplary embodiments, the casing comprises 2-7 layers, wherein a first alternating layer comprises at least one of PA 6, PA 6.6, or PE, and the second alternating layer comprises a sealant. In some exemplary embodiments, the casing comprises seven (7) layers, wherein the first and third layers, fifth and seventh layers, comprise at least one of PA 6, PA 6.6, or PE, and the second layer, fourth and sixth layers, comprise a sealant. In exemplary embodiments, the casing matrix comprises five layers, including a first layer comprising PA 6.6, a second layer comprising a sealant, a third layer comprising PE, a fourth layer comprising a sealant, and a fifth layer comprising PA 6.6. In exemplary embodiments, the casing matrix has a thickness of 30-90 microns. Optionally, the casing matrix further comprises puncture holes. In exemplary embodiments, the casing matrix further comprises at least one orifice or puncture hole, through the casing matrix. In exemplary embodiments, the casing matrix comprises a plurality of puncture holes. In exemplary embodiments, the puncture holes are inserted through the casing following construction of the casing, and prior to insertion of the foodstuff therein. In exemplary embodiments, the puncture holes improve slicing yield and by allowing any moisture not retained within the foodstuff following processing to evacuate from within the casing. This provides for a dry surface on the foodstuff, making it more adaptable to slicing post-processing. In exemplary embodiments, the puncture holes are created with a 10-20-gauge needle, and in some exemplary embodiments, a 14-18-gauge needle. In exemplary embodiments, the puncture holes are mm-30 mm apart from one another on the casing surface.

In exemplary embodiments, the biaxially-oriented casing matrix is capable of shrink greater than 3.5% at greater than 60% humidity, including greater than 70%, greater than 80%, greater than 90%, and greater than 100% humidity. In exemplary embodiments, the biaxially-oriented casing matrix is capable of shrink greater than 4.5% at greater than 96% humidity, including greater than 70%, greater than 80%, greater than 90%, and greater than 100% humidity s. In exemplary embodiments, the biaxially-oriented casing matrix is capable of shrink greater than 5.5% at greater than 60% humidity, including greater than 70%, greater than 80%, greater than 90%, and greater than 100% humidity. In exemplary embodiments, the biaxially-oriented casing matrix is capable of shrink greater than 6.5% at greater than 60% humidity, including greater than 70%, greater than 80%, greater than 90%, and greater than 100% humidity. In exemplary embodiments, the biaxially-oriented casing matrix is capable of shrink over 7.5% at greater than 60% humidity, including greater than 70%, greater than 80%, greater than 90%, and greater than 100% humidity. In exemplary embodiments, the biaxially-oriented casing matrix is capable of shrink over 7.5% at greater than 60% humidity at 175° C., including greater than 70%, greater than 80%, greater than 90%, and greater than 100% humidity. In exemplary embodiments, the biaxially-oriented casing matrix may be placed in any one of the abovementioned humidity conditions to achieve the abovementioned shrink percentage for greater than one millisecond, including, greater than one second, greater than 30 seconds, and between one millisecond and 10 minutes, or between five seconds and five minutes.

In exemplary embodiments, the casing comprises an adhesive layer. In exemplary embodiments, the adhesive layer is applied to the innermost layer of the casing matrix. In exemplary embodiments, the adhesive layer is a food grade adhesive layer. In exemplary embodiments, the casing comprises an adhesive layer in the amount of 10 to 70 milligrams of adhesive per square inch of the surface of the casing matrix. The adhesive may be any food grade adhesive material approved in terms of food regulations, in particular starches, modified starches, sugar-based carbohydrate glue, casein, collagen, carrageenan, alginate, carboxymethyl cellulose, and the like, adhesives soluble in a variety of solvents (e.g., water, fat, alcohol, etc.), permanent adhesives, lipids (e.g., lards, oils), oleoresin, gelatin, fiber-based adhesives (e.g., plant extract, biopolymer), slurries, sugar alcohol, syrups (e.g., corn syrup, flavored syrup, caramelized syrup, etc.), and gums (e.g., xanthan, arabic, carrageenan, etc.).

In exemplary embodiments, the casing further comprises at least one of an additive. The additive particulates embedded in or otherwise adhered with the adhesive layer may vary in type, amount, and size. The additive preferably comprises one or more of solids, particulates and/or liquid additives, including but not limited to, herbs (such as oregano, basil, or parsley), spices (such as paprika and curry), flavorings, seasonings, vegetables (such as broccoli or celery granules), nuts (including pine nuts or cashews), cheese particles, dextrose, pepper (including ground or whole corns), grains, or seeds (such as sesame or pumpkin seeds). At least one additive may comprise a liquid additive in an amount up to 20% of the weight of the at least one additive prior to application onto the adhesive layer. In exemplary embodiments, the additive covers 100% of the surface area of the adhesive layer, or 50-400 mg of additive per square inch of adhesive layer. In exemplary embodiments, the size of the additive particulates range from 0.5 um to 5 mm. The ratio of adhesive layer to additive varies depending on the type and amount of particulate that is to be applied to the interior of the casing. In one embodiment, the amount of adhesive relative to the amount of particulate may range from about 10% by weight to about 250% by weight.

In an exemplary embodiment, the adhesive layer may be configured to release the additive at a suitable release temperature and/or humidity. Where the additive is provided in the form of a particulate embedded in and/or covered by the adhesive layer, dissolution, melting, flaking, or other release of the adhesive layer allows for release of the particulate from the interior surface of the casing and onto the exterior surface of the item. Additionally or alternatively, particulate embedded in an adhesive layer may itself dissolve or otherwise detach due to heating, humidity, wetting and/or or other such treatment, independent of, and in some cases without, any dissolution or release of the adhesive layer.

In exemplary embodiments, the additive is applied to the adhesive layer via a metered application in a process wherein the additive affixes to adhesive layer without the use of heat. In exemplary embodiments, the casing exhibits no shrinkage during the additive application process. In exemplary embodiments, the casing has a shrink capacity after the additive transfer process (e.g., spice coating process) of greater than 4.5%. In some exemplary embodiments, the casing has a shrink capacity after the additive transfer process (e.g., spice coating process) of greater than 5.5%. In some exemplary embodiments, the casing has a shrink capacity after the additive transfer process (e.g., spice coating process) of greater than 6.5%. In some exemplary embodiments, the casing has a shrink capacity after the additive transfer process (e.g., spice coating process) of greater than 7.5%.

In exemplary embodiments, to facilitate optimal shrink capacity in the casing, the casing is exposed to at least one of high-humidity or high-temperature, and preferably high-humidity and high-temperature, for less than 10 minutes but greater than a millisecond, including less than 7 minutes, and including less than or equal to 5 minutes, in order to activate the casing shrink. In exemplary embodiments, the casing is exposed to 60% or greater humidity, including 70% or greater humidity, including 80% or greater humidity, including 90% or greater humidity, and including 99% or greater humidity. In exemplary embodiments, the casing is exposed to temperatures of between 100-200° F., including 120-175° F., and including 175° F. In exemplary embodiments, the casing is exposed to 100% humidity and 175° F. for between about 0.01-5 minutes. Biaxially-oriented polymer casings with heat-and humidity-activated shrink properties, such as those described herein, can be used to transfer spice coating affixed to the inside of said casing to the exterior of finished food products. During processing of the food product, e.g., cooking of the foodstuff within the casing, heat and humidity are applied causing the casing to shrink tightly around the foodstuff therein. It is beneficial to maximize the net shrink capacity of the casing during the processing of said foodstuff in order to increase the overall yield of food product and reduce the amount of purge occurring during processing.

Yield refers to the binding of moisture-such as water or natural juices-in foodstuff to increase the weight of the product, and thus the saleable volume of the foodstuff. Improvement of processing yield increases saleable volume and allows for extra moisture within the foodstuff relating to more succulent protein and limit package purge. Purge refers to the loss of moisture i.e., water or natural juices-and meat proteins occurring after processing of a food product. Percentage of purge refers to the percent of weight of food product lost during processing of the food product.

The casings described herein may be used in the production of processed food products, such as meats, vegetable, non-meat proteins, cheese, or any other food capable of being pumped through stuffing equipment. In exemplary embodiments, a method of transferring at least one additive to a foodstuff comprises introducing filling into a casing according to any of the casing embodiments set forth above, transferring said at least one additive to an external surface of the foodstuff, and processing the foodstuff within the casing.

In exemplary embodiments, the exterior surface of the food product inserted into the casing is coated with additives transferred from the inside of the exemplary casing. In exemplary embodiments, the additive transfers from the adhesive layer to the exterior surface of a foodstuff (e.g., meat) in a transfer process. According to an aspect of the present application, the environmental condition (e.g., pressure, temperature, moisture, etc.) for releasing the additive onto the foodstuff may be selected to provide a predetermined amount or degree of release of the additive. In exemplary embodiments, certain environmental conditions activate the adhesive layer, thereby releasing at least one additive from the inside surface of the casing and onto the exterior surface of the foodstuff. For example, a release condition (e.g., pressure, temperature or moisture content) may be selected to correspond to an initiation or beginning of a release of the coating additive. As another example, a release condition may be selected to correspond with release of a certain portion of the adhered additive (e.g., at least about 75% of the adhered additive) or by release of a certain portion of the combined adhesive and additive coating. Examples of release conditions include temperatures ranging from about 28° F. to about 200° F., moisture content ranging from about 18% to about 100%, time delay of about 15 minutes to about 2 hours or longer (depending on temperature), or some combination of two or more of these parameters. An amount or degree of additive release may be measured, for example, by weighing the casing before and after release conditions have been affected. In exemplary embodiments, the transfer of the additive to the exterior surface of the foodstuff occurs immediately. The food products processed within exemplary casings may be subsequently removed from the exemplary casing, sliced and repackaged, wherein most, or preferably substantially all, the additives transfer from inside surface of the casing to the outside surface of the foodstuff.

In exemplary embodiments, the casing can be used to make finished food products in various shapes including but not limited to round, d-Shaped, oval, or square. In exemplary embodiments, the casing is a biaxially-oriented heat-shrinkable casing.

As a result of the application of the adhesive layer without the use of heat, as described above, the amount of shrinkage exhibited by the casing after the additive application is maximized. In exemplary embodiments, the casing exhibits a net level of shrink of greater than 4.5%. In exemplary embodiments, the casing exhibits a net level of shrink of greater than 5.5%. In exemplary embodiments, the casing exhibits a net level of shrink of greater than 6.5%. In exemplary embodiments, the casing exhibits a net level of shrink of greater than 7.5%.

In exemplary embodiments, the casing described herein improves the processing yield on finished meat products and reducing the purge of moisture from said finished meat products. The additive transfer process draws moisture out of the foodstuffs, which then resides between the meat and casing. In many instances, 1-15% purge of said moisture is common. In exemplary embodiments, the casing described herein reduces purge by at least 1%.

As disclosed and suggested herein, the general inventive concepts relate to and contemplate a casing comprising a biaxially-oriented casing matrix, an adhesive layer, and one or more additives affixed to the adhesive layer, wherein the casing improves yield of a finished food product by 1% plus, and a method of use thereof.

It will be appreciated that many more detailed aspects of the illustrated processes are in large measure, known in the art, and these aspects have been omitted for purposes of concisely presenting the general inventive concepts.

What is claimed is:

1. A casing comprising (i) at least one biaxially-oriented matrix layer, (ii) an adhesion layer bound to at least one biaxially-oriented matrix layer, and (iii) at least one additive in contact with the adhesion layer, wherein the casing improves yield of a finished food product by greater than 1%.

2. The casing of claim 1, wherein the casing comprises one of a shirred tube, roll stock or cut pieces.

3. The casing of claim 1 further comprising a plurality of puncture holes.

4. The casing of claim 1, wherein the biaxially-oriented matrix comprises a first layer of PA 6 or PA 6.6, a second layer comprising a sealant, a third layer comprising PE, a fourth layer comprising a sealant, and a fifth layer comprising PA 6.6.

5. The casing of claim 1, wherein the biaxially-oriented matrix layer has a thickness of 30-90 microns.

6. The casing of claim 1, wherein adhesive layer is included in the amount of 10 to 70 milligrams of adhesive per square inch of the surface of the biaxially-oriented matrix layer.

7. The casing of claim 1, wherein the additive is included in an amount of 50-400 mg of additive per square inch of adhesive layer.

8. The casing of claim 1, wherein the casing has a shrink capacity after the additive transfer process (e.g., spice coating process) of greater than 4.5%.

9. The casing of claim 1, wherein the casing has a shrink capacity after the additive transfer process (e.g., spice coating process) of greater than 5.5%.

10. The casing of claim 1, wherein the casing has a shrink capacity after the additive transfer process (e.g., spice coating process) of greater than 6.5%.

11. A method of transferring at least one additive to a foodstuff comprising:
introducing filling into a casing, the casing comprising (i) at least one biaxially-oriented matrix layer, (ii) an adhesion layer bound to the at least one biaxially-oriented matrix layer, and (iii) at least one additive in contact with the adhesion layer,
transferring said at least one additive to an external surface of the foodstuff, and
processing the foodstuff within the casing, wherein the casing improves yield of a finished food product by 1%.

12. The method of claim 11, wherein the casing comprises a shirred tube.

13. The method of claim 11, wherein the biaxially-oriented matrix comprises a first layer of PA 6 or PA 6.6, a second layer comprising a sealant, a third layer comprising PE, a fourth layer comprising a sealant, and a fifth layer comprising PA 6.6.

14. The method of claim 11, wherein the biaxially-oriented matrix layer has a thickness of 30-90 microns.

15. The method of claim 11, wherein adhesive layer is included in the amount of 20 to 60 milligrams of adhesive per square inch of the surface of the biaxially-oriented matrix layer.

16. The method of claim 11, wherein the additive is included in an amount of 50-400 mg of additive per square inch of adhesive layer.

17. The method of claim 11, wherein the casing has a shrink capacity after the additive transfer process (e.g., spice coating process) of greater than 4.5%.

18. The method of claim 11, wherein the casing has a shrink capacity after the additive transfer process (e.g., spice coating process) of greater than 5.5%.

19. The method of claim 11, wherein the casing has a shrink capacity after the additive transfer process (e.g., spice coating process) of greater than 6.5%.

20. A food product encased by the casing of claim 1.
